(19) United States
(12) Patent Application Publication
(10) Pub. No.: US 2025/0072443 A1
(43) Pub. Date: Mar. 6, 2025

(54) LIQUID OR SEMI-SOLID FAT FORMULATIONS

(71) Applicant: Savor Foods Limited, San Jose, CA (US)

(72) Inventors: Aleesha Slattengren, San Jose, CA (US); Nikifar Lazouski, San Jose, CA (US); Kathleen Alexander, San Jose, CA (US)

(73) Assignee: Savor Foods Limited, San Jose, CA (US)

(21) Appl. No.: 18/818,047

(22) Filed: Aug. 28, 2024

Related U.S. Application Data
(60) Provisional application No. 63/579,205, filed on Aug. 28, 2023.

(51) Int. Cl. A23D 7/00; C11C 3/02

(52) U.S. Cl. CPC A23D 7/001; C11C 3/02

(57) ABSTRACT

A fat formulation can include triglycerides that include saturated fatty acids with carbon chain lengths between 4 and 24 carbon atoms long, wherein the fat formulation is a liquid or semi-solid at a temperature between 18-25° C. A fat formulation can additionally or alternatively include triglycerides comprising glycerol esterified with: odd carbon chain length, linear saturated fatty acids; even carbon chain length, linear saturated fatty acids; and unsaturated fatty acids. A method can include: optionally, receiving an unsaturated fatty acid; oxidizing hydrocarbons or oxygenates to form saturated fatty acids; selecting a distribution of saturated fatty acids from the formed saturated fatty acids; and esterifying glycerol with the unsaturated fatty acid and the distribution of saturated fatty acids to form a fat composition.

### CROSS-REFERENCE TO RELATED APPLICATIONS

This application claims the benefit of U.S. Provisional Application No. 63/579,205 filed 28 Aug. 2023, which is incorporated in its entirety by this reference.

### TECHNICAL FIELD

This invention relates generally to the fat formulations field, and more specifically to a new and useful fat formulation in the fat formulations field.

### BRIEF DESCRIPTION OF THE FIGURES

FIG. 1 is a schematic representation of an exemplary formulation.

FIG. 2 is a chart of approximate fatty acid melting points as a function of chain length.

FIG. 3 is a schematic representation of an example of a solid fat content as a function of temperature for an exemplary formulation.

FIG. 4A is a schematic representation of exemplary triglycerides that can be formed by interestification of capric acid, lauric acid, and stearic acid with glycerol. In this example, enantiomers and/or diastereomers of some triglycerides can be present (but are not explicitly listed).

FIG. 4B is a schematic representation of exemplary triglycerides that can be used in a formulation of tricaprin, trilaurin, and tristearin that are physically mixed (e.g., after the esters have been formed).

FIG. 5A is a tabular representation of exemplary liquid (“LIQ”) formulations.

FIG. 5B is a tabular representation of exemplary semi-solid (“GEL”) formulations.

FIG. 6 is a graphical representation of exemplary differential scanning calorimetry data for an exemplary room-temperature liquid and an exemplary room temperature semi-solid formulation (for one representative formulation from each of FIG. 5A and FIG. 5B).

FIG. 7 is a graphical representation of exemplary solid fat content as a function of temperature for several representative formulations (e.g., triglycerides with approximate relative proportions of fatty acid residues as shown in FIGS. 5A and 5B).

### DETAILED DESCRIPTION

The following description of the embodiments of the invention is not intended to limit the invention to these embodiments, but rather to enable any person skilled in the art to make and use this invention.

### 1. Overview

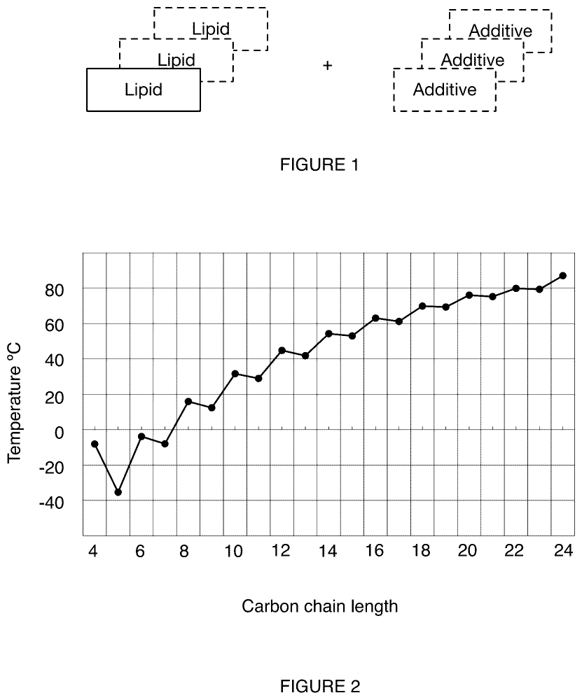

As shown in FIG. 1, the formulation can include one or more lipids 100 and optionally one or more additives 200. The formulation can be, for instance, an agriculture-free (e.g., does not include materials derived from agricultural products), an agriculture light (e.g., less than about 10% mass of the composition can be derived from agricultural products), animal-free (e.g., does not include materials derived from animal products or byproducts), animal light (e.g., less than about 10% mass of the composition can be derived from animal produced materials), and/or any suitable formulation. The lipids are preferably glycerides, where fatty acids of the glycerides are preferably greater than about 70% saturated fatty acids. In some examples, the fatty acids of the glycerides can be (e.g., consist of, consist essentially of, be composed of, be composed essentially of, etc.) saturated fatty acids. However, other suitable lipids can be used.

The formulation can be used, for example, as a substitute or artificial fat in food products (e.g., as a fat source in plant-based, fermentation-based, etc. product such as a fat for an artificial meat product), a baking or cooking oil (e.g., fat for baked goods, confections, chocolate, etc.), sauces (e.g., dips, dressings, condiments, etc.), emulsifier, infant formula supplement and/or breast-milk fat functional analogue, for cosmetics (e.g., skincare products, moisturizers, lotions, etc.), medicinal uses (e.g., topical medicine delivery), as a wax and/or resin, as a carrier (e.g., as a solvent for fat soluble materials such as colorants, vitamins, minerals, flavorants such as rosemary or thyme, in a slow-release capsule, etc.), and/or can be used for any suitable purpose. The formulation is preferably a food grade (e.g., generally recognized as safe (GRAS) for consumption) fat. For instance, the formulation can be used (alone or in combination with other formulations) in dairy-products (e.g., as a replacement fat, as a supplementary fat, etc. such as ice cream, milk, cream, butter, cheese, yogurt, ferments milk, custard, etc.), dairy-free alternative products (e.g., plant-derived dairy products, fermentation-derived dairy products, artificial dairy replacements, etc.), meats, cooking and/or frying oils (e.g., as a supplement to and/or in place of plant based oils such as canola oil, olive oil, vegetable oil, safflower oil, sesame oil, coconut oil, avocado oil, grapeseed oil, sunflower oil, peanut oil, corn oil, walnut oil, hemp seed oil, almond oil, flaxseed oil, mustard oil, palm oil, rice bran oil, pistachio oil, pecan oil, macadamia oil, apricot kernel oil, basil oil, Brazil nut oil, cashew oil, cocoa butter, cottonseed oil, hazelnut oil, palm kernel oil, rapeseed oil, soybean oil, castor oil, pumpkin seed oil, tea seed oil, algal oil, beach nut oil, Jamaican cobnut oil, mongongo nut oil, pine nut oil, lemon oil, orange oil, grapefruit seed oil, bitter gourd oil, bottle gourd oil, buffalo gourd oil, squash seed oil, Egusi seed oil, watermelon seed oil, açai oil, black seed oil, blackcurrant seed oil, borage seed oil, evening primrose oil, amaranth oil, apricot oil, apple seed oil, argan oil, babassu oil, ben oil, Borneo tallow nut oil, cape chestnut oil, carob pod oil, cocklebur oil, cohune oil, coriander seed oil, date seed oil, sika oil, false flax oil, kapok seed oil, kenaf seed oil, lallemantia oil, mafura oil, marula oil, meadowfoam seed oil, Niger seed oil, nutmeg butter, oiticica oil, okra seed oil, papaya seed oil, persimmon seed oil, perilla seed oil, perpequi oil, pili nut oil, pomegranate seed oil, poppyseed oil, pracaxi oil, prune kernel oil, quinoa oil, ramtil oil, royle oil, sacha inchi oil, sapote oil, seje oil, shea butter, taramira oil, thistle oil, tigernut oil, tobacco seed oil, tomato seed oil, wheat germ oil, colza oil, radish oil, Salicornia oil, etc.; as a supplement to or in place of animal fats for cooking and/or frying such as beef tallow, mutton tallow, schmaltz, suet, lard, butter, duck fat, goose fat, chicken fat, bacon grease, wild animal fat, fish fat, etc.; etc.), and/or can be used in any suitable situation. However, the formulation may not be food grade (e.g., when the formulation is used for livestock, for lotions, for creams, etc.).

The formulation is preferably a semi-solid (e.g., quasi-solid, falsely-solid, amorphous, gel, etc.) or a liquid at a target temperature (and target pressure). The target temperature can depend on an application (e.g., a food product that the formulation is to be incorporating in), depend on a coformulant (e.g., other fatty acid(s) that the formulation will be used in concert with), depend on an additive, depend on a location or region, and/or can otherwise be determined. As a specific example, the target temperature can be room temperature (e.g., 20-22° C., a temperature or range of temperatures between 15-30° C., about 20° C., etc.), a cold room temperature (e.g., 5-15° C.), a warm room temperature (e.g., 25-40° C.), ambient temperature for a region or time of year (e.g., a temperature or range within −25° C. and 45° C., a temperature or range within about −90° C. and 55° C., etc.), a refrigeration temperature (e.g., 1-3° C., 0-5° C., etc.), a freezer temperature (e.g., a temperature or range within about 20° C. and 0° C.), and/or can be any suitable temperature. The target pressure is typically approximately atmospheric pressure (at sea level or at another suitable elevation). However, the target pressure can be less than atmospheric pressure or greater than atmospheric pressure.

### 2. Technical Advantages

Variants of the technology can confer one or more advantages over conventional technologies.

First, variants of the technology can enable lower carbon footprint and/or carbon impact fats to be used. For instance, by using lipids (e.g., free fatty acids, esterified fatty acids, glycerolipids, etc.) derived from low or negative carbon footprint processes (e.g., processes that capture, trap, etc. carbon and convert the carbon to fatty acids, fatty esters, etc.), a low carbon footprint fat formulation can be produced. In some aspects of the invention, a carbon footprint and/or a land footprint to produce a fat or formulation can be less than a carbon footprint for an identical or analogous fat derived from agricultural processes. In some variations of the invention, using odd chain length fatty acids (in addition to or alternatively from) even chain length fatty acids can help lower a carbon footprint of the formulation (e.g., by reducing a total number of processing steps to prepare the fatty acids, by reducing an amount of waste, etc.).

Second, variants of the technology can facilitate and/or improve a performance of (e.g., improve a perception of, improve a quality of, improve an organoleptic property of, etc.) fat formulations that accurately, convincingly, and/or otherwise mimic properties of a fat to be replicated and/or perform a function of fat within a food product. For example, the fat formulations can be used (e.g., in a coformulation with other fat formulations such as disclosed in U.S. patent application Ser. No. 18/210,226 titled ‘FAT FORMULATIONS’ filed 15 Jun. 2023 or U.S. patent application Ser. No. 18/428,575 titled ‘MILKFAT OR BUTTERFAT FORMULATIONS’ filed 31 Jan. 2024, each of which is incorporated in its entirety by this reference) to result in a fat with a lower melting point and/or target solid fat content at a target temperature (than the other fat formulations without a coformulation) with less impact to complex thermodynamic behavior (e.g., more able to mimic a behavior of a fat to be replicated; thermal behavior that is broader, includes larger derivatives or higher order derivatives with respect to temperature, etc.; etc.) of the formulation.

Third, the inventors have found that formulations of (e.g., consisting of, composed of, including only, consisting essentially of, composed essentially of, etc.) saturated fatty acids can be selected that have semi-solid and/or liquid behavior at or near room temperature (e.g., solid fat content less than 10% at or near 20° C.).

However, further advantages can be provided by the system and method disclosed herein.

### 3. Fat Formulation

As shown in FIG. 1, the formulation can include one or more lipids and optionally one or more additives. The formulation can be, for instance, an agriculture-free (e.g., does not include materials derived from agricultural products), an agriculture light (e.g., less than about 10% mass of the composition can be derived from agricultural products), animal-free (e.g., does not include materials derived from animal products or byproducts), animal light (e.g., less than about 10% mass of the composition can be derived from animal produced materials), and/or any suitable formulation.

The composition of the formulation (e.g., the fatty acid composition such as the chain lengths, relative amounts of each fatty acid chain length, etc.; the additive composition such as types of additives, number of additives, additive concentration, etc.) can be selected based on a target fat profile and/or fat property. Examples of fat properties to achieve can include: thermodynamic behavior (e.g., melting point, melting profile, smoke point, enthalpy of melting, crystallization point, crystallization profile, crystallization phase, etc.), rheological behavior (e.g., slip point, viscosity, plasticity, consistency, flow, etc.), organoleptic behavior (e.g., taste, smell, feel, sound, appearance, color, mouth feel, etc.), optical properties (e.g., transparency, translucency, light scattering, color, refractive index, transmittance, reflectance, turbidity, birefringence, etc.), phase separation behavior (e.g., phase stability, ability to phase separate such as to form layers, etc.), emulsifying properties (e.g., surface tension, foaming, coalescence, avalanche, coarsening, foam drainage, dewetting, bursting, flocculation, creaming, sedimentation, Ostwald ripening, etc.), nutritional content (e.g., calorie content, fatty acid composition, etc.), foam structure (e.g., open cell foam, closed cell foam, cellular structures, etc.), pharmacological behavior (e.g., laxative effect, constipating effect, etc.), miscibility (e.g., with other fat formulations which is often corelated with the crystalline behavior of the fat formulation and in some variants might be tunable based on a location distribution of fatty acids within a triglyceride such as whether a longest chain fatty acid is more prevalent in an end position or a middle position of the glyceride), and/or any suitable property(s).

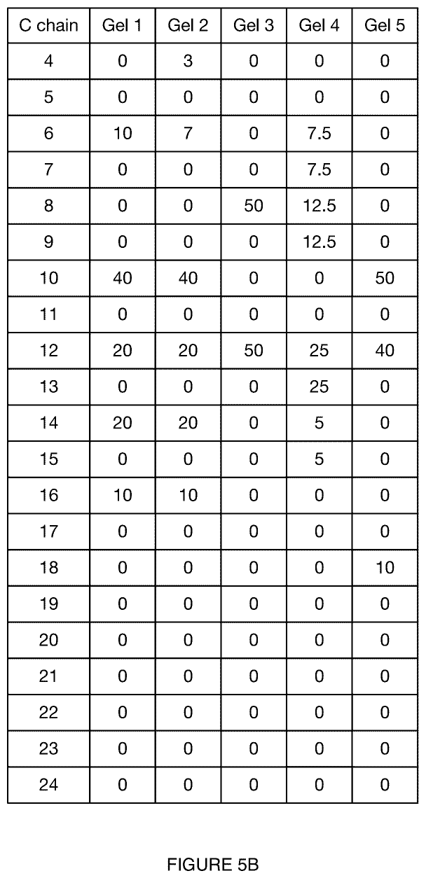

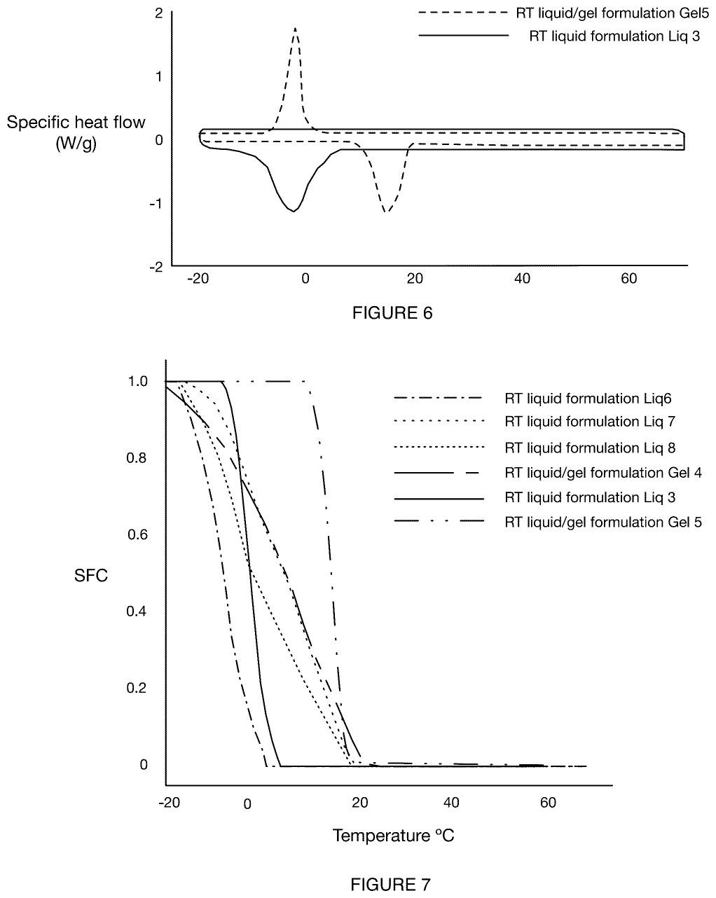

In one specific variant, the formulation is preferably a semi-solid (e.g., quasi-solid, falsely-solid, amorphous, gel, etc.) or a liquid at a target temperature (as shown for example in FIG. 6 or FIG. 7). In these variants, a semi-solid can refer to a formulation with a solid fat content between about 1% and 10% at the target temperature. In these variants, a liquid can refer to a formulation with a solid fat content less than about 1% at the target temperature. However, a semi-solid and/or liquid can otherwise be defined and/or the formulation could achieve other properties (e.g., a soft solid at the target temperature, spreadable solid, etc. for instance by retaining or concentrating heavier triglycerides formed by the formulation). In these specific variants, the formulation will often have a change in solid fat content from 90% to 10% over a temperature span of at most 20° C. (e.g., 15° C., 10° C., 7° C., etc.). However, the slope of the solid fat content can have any suitable value. The target temperature can depend on an application (e.g., a food product that the formulation is to be incorporating in), depend on a coformulant (e.g., other fatty acid(s) that the formulation will be used in concert with), depend on an additive, depend on a location or region, and/or can otherwise be determined. As a specific example (as shown for exemplary formulations in FIG. 6 or FIG. 7), the target temperature can be room temperature (e.g., 20-22° C., a temperature or range of temperatures between 15-30° C., about 20° C., etc.), a cold room temperature (e.g., 5-15° C.), a warm room temperature (e.g., 25-40° C.), ambient temperature for a region or time of year (e.g., a temperature or range within −25° C. and 45° C., a temperature or range within about −90° C. and 55° C., etc.), a refrigeration temperature (e.g., 1-3° C., 0-5° C., etc.), a freezer temperature (e.g., a temperature or range within about −20° C. and 0° C.), and/or can be any suitable temperature. Particularly (but not exclusively) for variants where the target temperature is between about 0° C. and 15° C., C4:0, C5:0, C6:0, and C7:0 can be particularly beneficial for achieving the target thermal properties (e.g., a formulation can include a majority of, these fatty acids can be at least 30% of the formulation, etc.). In some variants (e.g., to achieve liquid or semi-solid formulations below about −5° C.), C5:0 can be particularly beneficial.

In some variations (e.g., of the above variants and variations thereof), the composition of the formulation can be selected (e.g., tuned, determined, etc.) to achieve a target viscosity and/or target shear-stress (e.g., shear stress required to promote or undergo a thixotropic thinning and/or anti-thixotropic thickening). For example, greater variances in the fatty acid chain lengths, greater numbers of included fatty acids, and/or longer fatty acids typically result in higher viscosities (and vice versa for lower viscosities). As another example, unsaturated fatty acids can be included in the formulation as unsaturated fatty acids enable a partial decoupling between the rheologic properties and the thermal behavior of the formulation.

In some variations (e.g., of the above variants and variations thereof), the composition of the formulation can be selected (e.g., tunes, determined, etc.) to achieve a target lubricity (e.g., ability to reduce friction and/or wear, where the lubricity can be evaluated for instance using a four-ball wear test to evaluate a coefficient of friction) at a target lubricating temperature. For example, lipids that include (e.g., include a majority of, a plurality of, a supermajority of, include only, etc.) medium chain fatty acids (e.g., fatty acids with chain lengths between about 6 and 13 carbon atoms long) can lead to formulations with favorable lubricity. However, any suitable fatty acids can be used to achieve a target lubricity.

In some variations (e.g., of the above variants and variations thereof), the composition of the formulation can be selected to achieve a favorable smoke point and/or boiling point (e.g., at approximately 1 atm of pressure). For instance, the formulation can be chosen to generate a large range over which the formulation is liquid and can be used without generating rancidity and/or beginning to burn. For example, the smoke point can be modified (to some extent) based on an acidity and/or free fatty acid content within the formulation. In another example, the boiling point can be elevated by using greater amounts of longer chain (e.g., with chain lengths exceeding about 16 carbon atoms) fatty acids. However, the smoke point and/or boiling point can otherwise be controlled (e.g., based on the inclusion or absence of unsaturated fatty acids, based on the hydroxyl value of the formulation, etc.).

The formulation preferably predominantly includes lipids. For example, at least about 95% (e.g., 94.5%, 94.9%, 95.5%, 96%, 97%, 98%, 99%, 99.5%, 99.9%, 99.95%, 99.99%, 99.995%, 99.999%, 100%, etc. such as by mass, by volume, by stoichiometry, etc.) of the formulation can be lipids (including or excluding glycerol for the formation of triglycerides and other glycerolipids). However, in some variants, the formulation can include up to about 5% (e.g., by mass, by volume, by stoichiometry, etc.) of each additive (e.g., a formulation with two additives could have a composition that is about 5% a first additive, about 5% a second additive, and about 90% lipid), a formulation can include more than about 5% of one or more additive (e.g., 6%, 7%, 8%, 10%, 15%, etc.), and/or the formulation can have any suitable composition.

The lipids are preferably derived from a chemical process (e.g., oxidation of paraffins, from captured carbon dioxide, from natural gas, from carbon monoxide, from syngas, from coal, from biomass, from a Fischer-Tropsch synthesis, from a Ziegler-method synthesis, artificial fatty acids, etc.; optionally including fractionation, separation, and/or purification processes; as described for example in U.S. patent application Ser. No. 18/807,247 titled ‘SYSTEM AND METHOD FOR TRIGLYCERIDE MANUFACTURE’ filed 16 Aug. 2024 which is incorporated in its entirety by this reference), but can additionally or alternatively be cultured (e.g., produced via cells), derived from biological and/or agricultural processes (e.g., fatty acids obtained from plants, fungi, microbes, animals, etc.), and/or can otherwise be obtained or derived.

The lipids preferably include fatty acids with a chain length between 4 and 24 carbons long. However, shorter fatty acids (or short chain carboxylic acids), longer fatty acids (e.g., 25, 26, 27, 28, 29, 30, 40, values therebetween, etc. carbon atoms long), and/or other lipids can be included in the formulation.

In preferred examples, the lipid composition of the formulation preferably includes greater than about 50% (e.g., by mass, by volume, by stoichiometry, etc. where the approximate can exclude the mass contribution of glycerol or other alcohols used to form fatty esters, can account for batch-to-batch variations, etc.) carboxylic acids with chain lengths less than 11 carbon atoms. In related examples, the lipid composition can include less than about 10% (e.g., by mass, by volume, by stoichiometry, etc. where the approximate can exclude the mass contribution of glycerol or other alcohols used to form fatty esters, can account for batch-to-batch variations, etc.) carboxylic acids with chain lengths greater than or equal to 18 carbon atoms. In related examples, the lipid composition can include less than about 20% (e.g., by mass, by volume, by stoichiometry, etc. where the approximate can exclude the mass contribution of glycerol or other alcohols used to form fatty esters, can account for batch-to-batch variations, etc.) carboxylic acids with chain lengths greater than or equal to 16 carbon atoms. In related examples, the lipid composition can include less than about 30% (e.g., by mass, by volume, by stoichiometry, etc. where the approximate can exclude the mass contribution of glycerol or other alcohols used to form fatty esters, can account for batch-to-batch variations, etc.) carboxylic acids with chain lengths greater than or equal to 14 carbon atoms. However, formulations can be formed that meet the target properties of the formulation without meeting all of the criterion of these specific examples (for instance a formulation can include about 20% C18+ fatty acids—referring to fatty acids with 18 or more carbon atoms in chain length—but would likely need the remainder of the formulation to include fatty acids with chain lengths less than about 9 carbon atoms long).

The fatty acids are preferably saturated fatty acids, but can include unsaturated fatty acids (e.g., aromatic fatty acids, cyclic fatty acids, including double or triple bonds, etc.). The fatty acids are preferably linear (e.g., straight-chain, unbranched, etc.), but can additionally or alternatively be nonlinear (e.g., branched, cyclic, etc.). In a specific example, the lipids of the formulation can consist essentially of linear fatty acids (e.g., >90% linear, >95% linear, >98% linear, >99% linear, >99.9% linear, >99.99% linear, etc.; linear fatty acids; etc.). As a second specific example, the lipids of the formulation can consist of linear fatty acids. As a third specific example, the lipids of the formulation can include up to about 30% (e.g., by mass, by volume, by stoichiometry, etc. on a free fatty acid basis) unsaturated fatty acids (where the remaining free fatty acid composition of the formulation is preferably linear saturated fatty acids). In variations of the third specific example, the unsaturated fatty acids portion of the formulation can include one or more of: C4:1 fatty acid (e.g., crotonic acid), C5:1 fatty acid, C6:1 fatty acid, C7:1 fatty acid, C8:1 fatty acid, C9:1 fatty acid, C10:1 fatty acid, C11:1 fatty acid, C12:1 fatty acid, C13:1 fatty acid, C14:1 fatty acid (e.g., myristoleic acid, C15:1 fatty acid, C16:1 fatty acid (e.g., palmitoleic acid, sapienic acid, etc.), C17:1 fatty acid, C18:1 fatty acid (e.g., vaccenic acid, oleic acid, elaidic acid, etc.), C19:1 fatty acid, C20:1 fatty acid (e.g., paullinic acid, gondoic acid, gadoleic acid, eicosenoic acid, etc.), C21:1 fatty acid, C22:1 fatty acid (e.g., erucic acid), C23:1 fatty acid, C24:1 fatty acid (e.g., nervonic acid), C5:2 fatty acid, C6:2 fatty acid, C7:2 fatty acid, C8:2 fatty acid, C9:2 fatty acid, C10:2 fatty acid, C11:2 fatty acid, C12:2 fatty acid, C13:2 fatty acid, C14:2 fatty acid, C15:2 fatty acid, C16:2 fatty acid, C17:2 fatty acid, C18:2 fatty acid (e.g., linoleic acid, linolelaidic acid, etc.), C19:2 fatty acid, C20:2 fatty acid (e.g., eicosadienoic acid), C21:2 fatty acid, C22:2 fatty acid (e.g., docosadienoic acid), C23:2 fatty acid, C24:2 fatty acid, C7:3 fatty acid, C8:3 fatty acid, C9:3 fatty acid, C10:3 fatty acid, C11:3 fatty acid, C12:3 fatty acid, C13:3 fatty acid, C14:3 fatty acid, C15:3 fatty acid, C16:3 fatty acid, C17:3 fatty acid, C18:3 fatty acid (e.g., linolenic acid, pinolenic acid, eleosteric acid, catalpic acid, punicic acid, etc.), C19:3 fatty acid, C20:3 fatty acid (e.g., dihomo-γ-linoleic acid, mead acid, eicosatrienoic acid, etc.), C21:3 fatty acid, C22:3 fatty acid, C23:3 fatty acid, C24:3 fatty acid, C9:4 fatty acid, C10:4 fatty acid, C11:4 fatty acid, C12:4 fatty acid, C13:4 fatty acid, C14:4 fatty acid, C15:4 fatty acid, C16:4 fatty acid, C17:4 fatty acid, C18:4 fatty acid (e.g., stearidonic acid), C19:4 fatty acid, C20:4 fatty acid (e.g., arachidonic acid, eicosatetraenoic acid, etc.), C21:4 fatty acid, C22:4 fatty acid (e.g., docosatetraenoic acid, adrenic acid, etc.), C23:4 fatty acid, C24:4 fatty acid, C11:5 fatty acid, C12:5 fatty acid, C13:5 fatty acid, C14:5 fatty acid, C15:5 fatty acid, C16:5 fatty acid, C17:5 fatty acid, C18:5 fatty acid, C19:5 fatty acid, C20:5 fatty acid (e.g., eicosapentaenoic acid, bosseopentaenoic acid, etc.), C21:5 fatty acid, C22:5 fatty acid (e.g., ozubondo acid, clupanodonic acid, etc.), C23:5 fatty acid, C24:5 fatty acid (e.g., tetracosapentaenoic acid), C13:6 fatty acid, C14:6 fatty acid, C15:6 fatty acid, C16:6 fatty acid, C17:6 fatty acid, C18:6 fatty acid, C19:6 fatty acid, C20:6 fatty acid, C21:6 fatty acid, C22:6 fatty acid (e.g., cervonic acid), C23:6 fatty acid, C24:6 fatty acid (e.g., herring acid, nisinic acid, etc.), and/or other suitable unsaturated fatty acid. In these variations, the glycerides are preferably formed from a mixture of the saturated and unsaturated fatty acids. However, the glycerides can include a mixture of glycerides consisting of saturated fatty acids with glycerides consisting of unsaturated fatty acids. In these variations, the unsaturated fatty acid(s) are preferably cis isomers (e.g., each double bond has a cis configuration). However, in some variants (particularly but not necessarily for nonfood applications), a trans isomer and/or a mixture of cis and trans isomers can be used. However, the formulation (and/or lipids thereof) can include any suitable fatty acids (e.g., a formulation that includes unsaturated fatty acids).

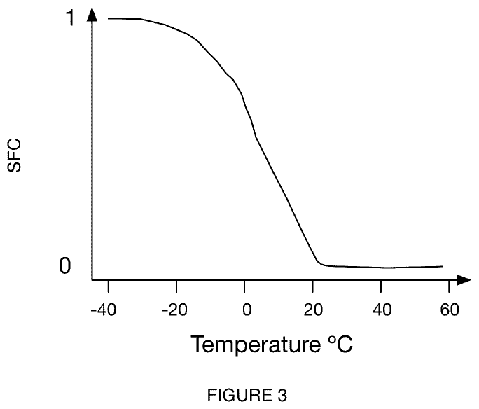

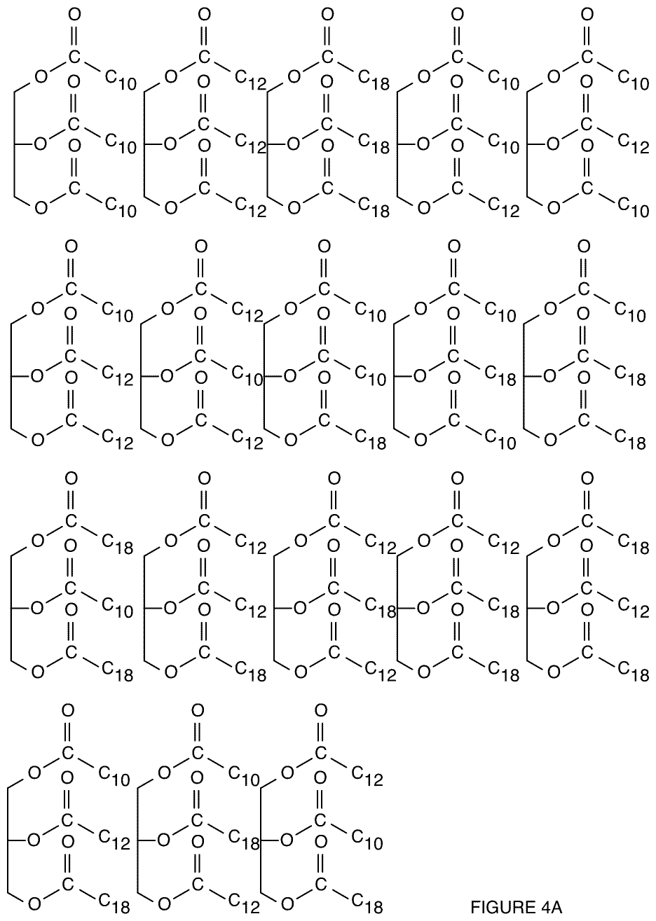

The formulation can be a gapless formulation and/or be a gapped formulation (e.g., as described in U.S. patent application Ser. No. 18/210,207, titled ‘FAT FORMULATIONS’ filed 15 Jun. 2023, which is incorporated in its entirety by this reference). A gap preferably refers to one or more missing (e.g., formulation contains 0%, formulation contains less than about 5% of, etc.) even and/or even and odd pair (where even and odd pair generally refers to an even fatty acid and a fatty acid with one more carbon atom than the even fatty acid; refers to fatty acids with similar melting points such as differing by less than 10° C. as shown for example in FIG. 2; etc.) of fatty acids from the formulation. Typically, variants that include a gap will leverage a large gap (e.g., at least four missing fatty acids within the gap, at least 6 missing fatty acids within the gap, etc.) to achieve preferred properties (particularly melting point and/or viscosity but additionally or alternatively other suitable properties). However, formulations with smaller gaps can achieve the target properties. As an illustrative example, a formulation that includes fatty acids with C10:0 (e.g., capric acid) and C14:0 (e.g., myristic acid) fatty acids would be a gapped formulation as C12:0 (e.g., lauric acid) and C13:0 (e.g., tridecylic acid) are not in the formulation. As a second illustrative example, a formulation that includes fatty acid C10:0 and C12:0 fatty acids would generally not be referred to as a gapped formulation (but rather as an even-only formulation).

A formulation can include a single gap (e.g., be missing a single even carbon or even and odd pair carbon chain) and/or can include a plurality of gaps (e.g., 2 gaps, 3 gaps, 4 gaps, etc.).

In some variants, rather than a gapped formulation, a formulation can be a nonmonotonically decreasing formulation (e.g., include a nonmonotonically decreasing distribution of fatty acids from short-chain fatty acids to long-chain fatty acids or analogously a non-monotonically increasing distribution of fatty acids from long-chain fatty acids to short-chain fatty acids). In the limit that a local minimum fatty acid chain is not present could result in a gapped formulation. The inclusion of a nonmonotonically decreasing distribution can be beneficial for achieving complex behavior (e.g., thermal behavior, rheological properties, etc.) in the fat composition. Additionally, or alternatively, the nonmonotonically decreasing distribution can be beneficial for utilization of fatty acids derived from an as-synthesized distribution and/or can provide any suitable technical advantage.

In some variants of a gapless formulation, the formulation can monotonically decrease (and/or stay constant) from a short carbon chain fatty acid to a long carbon chain fatty acid. Examples of such distribution could include constant distribution (e.g., square distribution), triangle distribution, exponential distributions, and/or other suitable distribution. In other variants of a gapless formulation, the formulation can have other suitable structure (e.g., gaussian distribution, skewed gaussian distribution such as with a greater proportion of short chain fatty acids, polymodal distribution, etc.). Additionally or alternatively, gapped formulation can have similar bounding distributions but exclude intermediate fatty acids (e.g., fatty acid pairs).

In some variants, the formulation can include only even chain length fatty acids. These variants can be beneficial as even chain length fatty acids are generally recognized as safe to consume and/or can otherwise be beneficial. In other variants, the formulation can include even and odd chain length fatty acids. These variants can be beneficial for producing less waste, requiring less processing (e.g., fewer separations, less fractionation, less refinement, etc.), and/or can otherwise be beneficial. Typically, in variants with even and odd chain length fatty acids, the even and odd pair fatty acids are in approximately the same proportion. However, the proportion of the fatty acids of a pair need not be approximately the same (e.g., a formulation could include more of the even or odd member of an even-odd fatty acid pair for instance leveraging the difference in melting point between the two). In other variants, the fat formulation could include only odd chain length fatty acids, which may be beneficial for using materials remaining from other fat formulations (e.g., using separated fatty acids from an even-only chain formulation) or for providing metabolically advantageous properties (e.g., anti-inflammatory, anticarcinogenic, antioxidant, antibiotic, non-cytotoxic immunosuppressive, glucogenic, etc.; have an inverse relationship with disease development for: atherosclerosis, prediabetes and type II diabetes, coronary heart disease, insulin sensitivity, etc.; etc.) to food products. However, the formulation can include any suitable fatty acid(s).

The lipids can include free fatty acids, fatty acid esters (e.g., esters of fatty acids with glycerol such as mono glycerides such as 1-glycerides, 2-glycerides; diglycerides such as 1,2-glycerides, 1,3 glycerides; triglycerides; etc.), and/or any suitable lipids. In a first specific example, the lipids can consist essentially of (e.g., be composed essentially of, include only, consist of, be composed of, etc.) triglycerides. In a second specific example, the lipids can include a mixture of diglycerides and triglycerides. In the second specific example, the diglycerides can be beneficial for forming emulsions of the formulation (e.g., in water, solvent, etc.), can be beneficial for modifying and/or controlling mechanical properties of the formulation, and/or can provide any suitable technical advantage. In the second specific example, the triglycerides are preferably at least about 50% (e.g., 60%, 70%, 75%, 80%, 85%, 90%, 95%, 97%, 98%, 99%, 99.5%, 99.9%, etc. where percentage can refer to mass percent, volume percent, stoichiometric percent, composition percent, etc.) of the lipid composition. Variants of the second specific example can include monoglycerides (preferably, but not necessarily, substituting for or replacing a portion of the diglyceride composition without modifying the triglyceride composition) and/or replace the diglycerides with monoglycerides. However, the lipids can include any suitable esters.

The hydroxyl number (e.g., the number of milligrams of potassium hydroxide required to neutralize acetic acid taken up on acetylation of one gram of a chemical substance that contains free hydroxyl groups which can be a value for approximate monoglyceride and/or diglyceride concentration of the formulation) of the fat formulation is preferably less than about 100 (e.g., 0-100, 0-5, 0-10, 0-20, 1-5, 5-10, 5-20, 10-20, 15-30, 20-30, 20-50, 30-75, 20-80, 50-95, 90-99, 30-100, 40-100, 50-100, 75-100, values or ranges therebetween), but can have any suitable value. Larger hydroxyl numbers (e.g., values closer to 100) may provide a technical advantage of having less thermal hysteresis, softer formulations, and/or other suitable properties. In variations, the hydroxyl number can be determined according to a method as described in ASTM E1899, EN 15168, ASTM D1957, ASTM E222-10, and/or in any suitable manner.

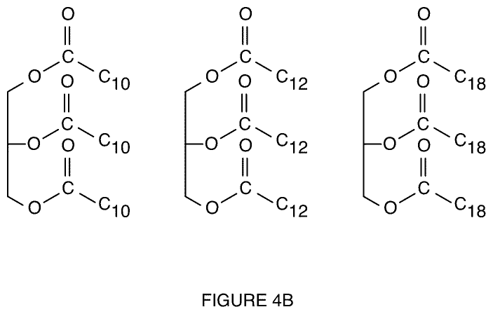

When the lipids include esters (particularly but not exclusively triglycerides, esters of glycerol, etc.), the fatty acids of the esters can form heteroesters (e.g., as shown for example in FIG. 4A) and/or can form homoesters (e.g., as shown for example in FIG. 4B, physically mixed, etc.). For instance, to form a heteroester formulation, free fatty acids (e.g., of a distribution of free fatty acids) can be mixed and esterified simultaneously. Similarly, to form a homoester formulation, free fatty acids can be separately esterified, and the resulting esters can be mixed. However, the esters can otherwise be formed.

In some variants, rather than forming a substantially stochastic distribution of glycerides, one or more potential glyceride can be removed from and/or added into the formulation (i.e., resulting in a nonstochastic distribution of glycerides). As an illustrative example, a formulation formed using 50% C8 and 50% C14 would be expected to form triglycerides in an approximate ratio of 1:3:3:1 for C8/C8/C8:C8/C8/C14:C8/C14/C14:C14/C14/C14 triglycerides. In an illustrative example of these variants, however, the approximate ratio could be skewed such as to 1:3:3:0 for C8/C8/C8:C8/C8/C14:C8/C14/C14:C14/C14/C14 triglycerides (where the heaviest potential triglycerides and/or diglycerides are typically preferably excluded from the formulation as they are likely to have the largest melting point). However, other similar nonstoichiometric distributions can be used. As a specific example, the formulation can have less than stochastically predicted amount of homoglycerides formed with carbon chains greater than about C14 (e.g., removed by filtration for instance by removing fat particles from a mostly liquid solution). However, other suitable cutoff sizes can be used and/or changes to the distribution of glycerides can result.

In variants of the formulation, particularly but not exclusively for food products and/or cooking applications, a free fatty acid content of the formulation is preferably small, which can be beneficial for avoiding and/or minimizing rancidity in the formulation (e.g., resulting from a rancid smell of the free fatty acid such as for C7:0; resulting from oxidation, smoking, degradation, etc. of the free fatty acid; etc.). For instance, the free fatty acid content can be less than 1 ppb, 5 ppb, 10 ppb, 50 ppb, 100 ppb, 500 ppb, 1 ppm, 5 ppm, 10 ppm, 50 ppm, 100 ppm, 500 ppm, 0.1%, 0.5%, 1%, values or ranges therebetween, and/or can be any suitable portion of the formulation.

The additives can function to modify one or more properties of the formulations. Exemplary properties can include: taste, surface tension, lipid solubility, nutritional value, rheological behavior, properties of the formulation to mimic a target fat, oxidation, optical properties (e.g., color, reflectance, translucence, etc.), and/or any suitable properties. Exemplary additives include flavorants, antioxidants, glycerides (e.g., monoglycerides, diglycerides, etc. such as of fatty acids of the formulation), byproducts (e.g., from a fatty acid synthesis, from esterification, etc.), nutritional additives, colorants, and/or any suitable additives. Additives are preferably GRAS certified (e.g., are food safe, are considered safe to consume, etc.). However, in some variants, the additives may not have GRAS certification and/or may not be food safe.

Flavorants can function to modify a taste and/or smell of the formulation. Flavorants can include: esters, aldehydes, ketones, lactones (e.g., γ-lactones, δ-lactones, macrocyclic lactones, polycyclic lactones, etc.), acids (e.g., lactic acid), alcohols, and/or any suitable flavorants. For example, short chain (e.g., with between about 1 and 7 carbon atoms) fatty acids, fatty aldehydes, fatty ketones, fatty acid methyl esters, fatty alcohols, and/or any suitable materials can be used as flavorants. Typically, the flavorant concentration within the formulation is small (e.g., less than 0.1% such as 1 ppb, 10 ppb, 100 ppb, 1 ppm, 10 ppm, 100 ppm, 500 ppm, 1000 ppm, etc.). However, the flavorant concentration can be greater than 0.1%.

Nutritional additives can function to modify a nutritional content of the formulation. For example, nutritional additives can add essential (or nonessential) nutrients (e.g., vitamins, minerals, etc.), modify a calorie density of the formulation, and/or can otherwise modify a nutritional content of the formulation. Exemplary nutritional additives include: fat-soluble vitamins, essential fatty acids, conditionally essential fatty acids, unsaturated fatty acids (such as (2-3, 22-6, 22-9, oleic acid, etc, particularly as free fatty acids, but optionally included with the glycerides), carbohydrates or other sweetener, minerals (e.g., lithium, sodium, potassium, rubidium, magnesium, calcium, strontium, vanadium, chromium, manganese, iron, cobalt, nickel, copper, zinc, molybdenum, tungsten, lanthanum, cerium, praseodymium, neodymium, samarium, boron, aluminium, silicon, germanium, tin, phosphorus, sulphur, selenium, fluorine, chlorine, bromine, iodine, etc.), water-soluble minerals or vitamins (e.g. folate, thiamine, riboflavin, niacin, pantothenic acid, biotin, vitamin B6, vitamin B12, vitamin C), any suitable nutritional additives can be used.

Colorants can function to modify a color or appearance of the formulation. For instance, colorants can be added to make a formulation match an expected color for a given product, for tracing, for holiday themes, to promote and/or discourage consumption, for cosmetic purposes, and/or can otherwise be used.

Coformulations formed by combining a formulation as disclosed herein with another fat formulation or composition (e.g., an animal fat mimic as disclosed in U.S. patent application Ser. No. 18/210,226, titled ‘FAT FORMULATIONS’ filed 15 Jun. 2023 or a milkfat analogue as disclosed in U.S. patent application Ser. No. 18/428,575 titled ‘MILKFAT OR BUTTERFAT FORMULATIONS’ filed 31 Jan. 2024, each of which is incorporated in its entirety by this reference; an animal fat; a plant fat; etc.) are typically formed to achieve a target melting point. However, additionally or alternatively, a coformulation can additionally or alternatively be formed to achieve a target rheological behavior (e.g., slip point, viscosity, plasticity, consistency, flow, etc.), thermodynamic behavior (e.g., melting profile, smoke point, boiling point, enthalpy of melting, crystallization point, crystallization profile, crystallization phase, etc.), organoleptic behavior (e.g., taste, smell, feel, sound, appearance, color, mouth feel, etc.), optical property (e.g., transparency, translucency, light scattering, color, refractive index, transmittance, reflectance, turbidity, birefringence, etc.), phase separation behavior (e.g., phase stability, ability to phase separate such as to form layers, etc.), emulsifying properties (e.g., surface tension, foaming, coalescence, avalanche, coarsening, foam drainage, dewetting, bursting, flocculation, creaming, sedimentation, Ostwald ripening, etc.), foam structure (e.g., open cell foam, closed cell foam, cellular structures, etc.), pharmacological behavior (e.g., laxative effect, constipating effect, etc.), and/or any suitable property(s).

Typically, properties of a coformulation will be approximately an arithmetic mean between the properties of the separate formulations mixed to form the coformulation. For example, to achieve a melting temperature of about 30° C., a first formulation with a melting temperature of about 15° C. could be mixed with a second formulation with a melting temperature of about 40° C. in a ratio of about 2:3 (i.e., about 40% of the first formulation and about 60% of the second formulation on a weight basis). However, the properties of the coformulation can be a geometric mean, a weighted mean, a harmonic mean, and/or other suitable measure of central tendency between the properties of the individual formulations, can be nonlinearly related to properties of the individual formulations (e.g., a coformulation can have a higher or a lower melting point than the separate formulations), and/or can otherwise be determined (e.g., predicted, estimated, related to, etc.) from the individual formulations.

### 4. Specific Examples

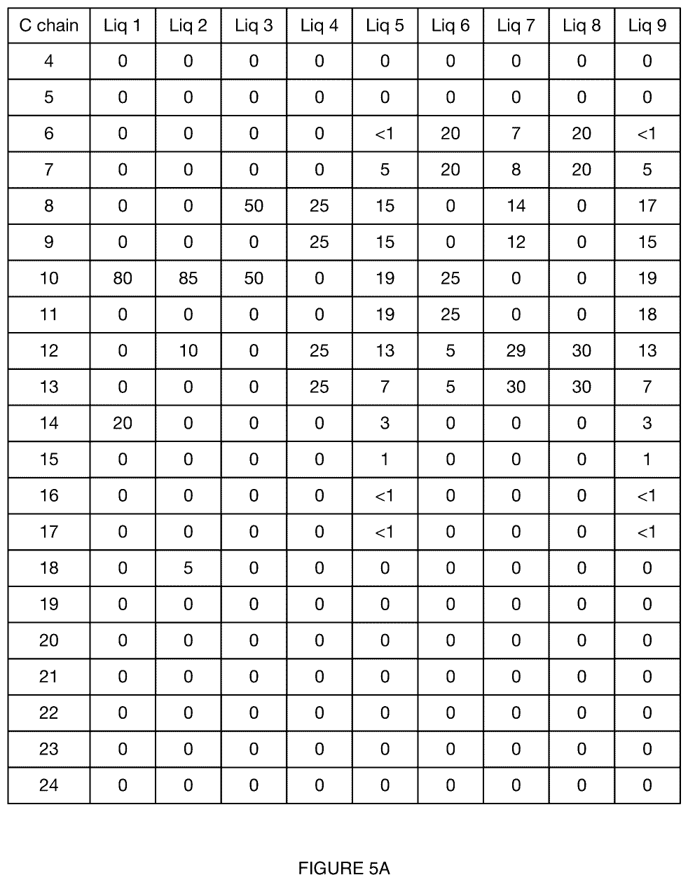

In a first illustrative example of a room-temperature liquid formulation (as shown for instance in Liq 1 in FIG. 5A), a lipid composition of a fat formulation can include about 80% (e.g., 70-90%) capric acid and about 20% (e.g., 10-30%) myristic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The formulation can be a gapped formulation (e.g., excluding lauric acid). The fatty acids are preferably artificially manufactured, but can be naturally derived (e.g., recovered or sourced from plants, animals, fungi, microbial fermentation, etc.) and/or can otherwise be produced. In some variations, C10:0 fatty acid can be replaced or substituted (in part or in whole) with C11:0 (e.g., the about 80% could be 40% C10:0 and 40% C11:0 or 80% C11:0 fatty acid) and C14:0 fatty acid can be replaced or substituted (in part or in whole) with C15:0 fatty acid.

In a second illustrative example of a room-temperature liquid formulation (as shown for instance in Liq 2 of FIG. 5A), a lipid composition of a fat formulation can include about 85% (e.g., 80-90%) capric acid, about 10% (e.g., 5-15%) lauric acid, and about 5% (e.g., 2.5-7.5%) stearic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. In some variations, C10:0 fatty acid can be replaced or substituted (in part or in whole) with C11:0 (e.g., the about 85% could be 42.5% C10:0 and 42.5% C11:0 or 85% C11:0 fatty acid), C12:0 fatty acid can be replaced or substituted (in part or in whole) with C13:0, and C14:0 fatty acid can be replaced or substituted (in part or in whole) with C15:0 fatty acid.

In a third illustrative example of a room-temperature liquid formulation (as shown for instance in Liq 3 of FIG. 5), a lipid composition of a fat formulation can include about 50% (e.g., 30-70%) caprylic acid and about 50% (e.g., 30-70%) capric acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. In some variations, C8:0 fatty acid can be replaced or substituted (in part or in whole) with C9:0 (e.g., the about 50% could be 25% C8:0 and 25% C9:0 or 50% C9:0 fatty acid) and C10:0 fatty acid can be replaced or substituted (in part or in whole) with C11:0 fatty acid.

In a fourth illustrative example of a room-temperature liquid formulation (as shown for instance in Liq 4 of FIG. 5), a lipid composition of a fat formulation can include about 25% (e.g., 20-30%) caprylic acid, about 25% (e.g., 20-30%) pelargonic acid, about 25% (e.g., 20-30%) lauric acid, and about 25% (e.g., 20-30%) tridecylic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced.

In a fifth illustrative example of a room-temperature liquid formulation (as shown for instance in Liq 5 or Liq 9 of FIG. 5), a lipid composition of a fat formulation can include about 5% (e.g., 2.5-7.5%) enanthic acid, about 15% (e.g., 10-20%) caprylic acid, about 15% (e.g., 10-20%) pelargonic acid, about 20% (e.g., 15-25%) capric acid, about 20% (e.g., 15-25%) undecylic acid, about 15% (e.g., 10-20%) lauric acid, about 7.5% (e.g., 5-10%) tridecylic acid, and about 5% (e.g., 2.5-7.5%) myristic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. Variations of the fifth illustrative example can include trace amounts of (e.g., less than or equal to about 1%) pentadecylic acid, caproic acid, palmitic acid, margaric acid, and/or any suitable acid(s).

In a sixth illustrative example of a room-temperature liquid formulation (as shown for instance in Liq 6 of FIG. 5), a lipid composition of a fat formulation can include about 20% (e.g., 15-25%) caproic acid, about 20% (e.g., 15-25%) enanthic acid, about 25% (e.g., 20-30%) capric acid, about 25% (e.g., 20-30%) undecylic acid, about 5% (e.g., 2.5-7.5%) lauric acid, and about 5% (e.g., 2.5-7.5%) tridecylic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced.

In a seventh illustrative example of a room-temperature liquid formulation (as shown for instance in Liq 7 of FIG. 5), a lipid composition of a fat formulation can include about 7.5% (e.g., 5-10%) caproic acid, about 7.5% (e.g., 5-10%) enanthic acid, about 12.5% (e.g., 10-15%) caprylic acid, about 12.5% (e.g., 10-15%) pelargonic acid, about 30% (e.g., 25-35%) lauric acid, and about 30% (e.g., 25-35%) tridecylic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced.

In an eighth illustrative example of a room-temperature liquid formulation (as shown for instance in Liq 8 of FIG. 5), a lipid composition of a fat formulation can include about 20% (e.g., 15-25%) caproic acid, about 20% (e.g., 15-25%) enanthic acid, about 30% (e.g., 25-35%) lauric acid, and about 30% (e.g., 25-35%) tridecylic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced.

In a first illustrative example of a room-temperature semi-solid (e.g., gel) formulation (as shown for instance in Gel 1 of FIG. 5B), a lipid composition of a fat formulation can include about 10% (e.g., 5-15%) caproic acid, about 40% (e.g., 30-50%) capric acid, about 20% (e.g., 15-25%) lauric acid, about 20% (e.g., 15-25%) myristic acid, and about 10% (e.g., 5-15%) palmitic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. Variations of the first illustrative example can melt by (e.g., have a solid fat content of 0) between about 25° C. and 30° C. In some variations, C6:0 fatty acid can be replaced or substituted (in part or in whole) with C7:0 (e.g., the about 10% could be 5% C6:0 and 5% C7:0 or 10% C7:0 fatty acid), C10:0 fatty acid can be replaced or substituted (in part or in whole) with C11:0 fatty acid, C12:0 fatty acid can be replaced or substituted (in part or in whole) with C13:0 fatty acid, C14:0 fatty acid can be replaced or substituted (in part or in whole) with C15:0 fatty acid, and C16:0 fatty acid can be replaced or substituted (in part or in whole) with C17:0 fatty acid.

In a second illustrative example of a room-temperature semi-solid (e.g., gel) formulation (as shown for instance in Gel 2 of FIG. 5B), a lipid composition of a fat formulation can include about 2.5% (e.g., 1-5%) butyric acid, about 7.5% (e.g., 5-10%) caproic acid, about 40% (e.g., 30-50%) capric acid, about 20% (e.g., 15-25%) lauric acid, about 20% (e.g., 15-25%) myristic acid, and about 10% (e.g., 5-15%) palmitic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. Variations of the second illustrative example can melt by about 25-30° C. (e.g., have a solid fat content less than 1% by this temperature). In some variations, C4:0 fatty acid can be replaced or substituted (in part or in whole) with C5:0 fatty acid, C6:0 fatty acid can be replaced or substituted (in part or in whole) with C7:0 (e.g., the about 10% could be 5% C6:0 and 5% C7:0 or 10% C7:0 fatty acid), C10:0 fatty acid can be replaced or substituted (in part or in whole) with C11:0 fatty acid, C12:0 fatty acid can be replaced or substituted (in part or in whole) with C13:0 fatty acid, C14:0 fatty acid can be replaced or substituted (in part or in whole) with C15:0 fatty acid, and C16:0 fatty acid can be replaced or substituted (in part or in whole) with C17:0 fatty acid.

In a third illustrative example of a room-temperature semi-solid (e.g., gel) formulation (as shown for instance in Gel 3 of FIG. 5B), a lipid composition of a fat formulation can include about 50% (e.g., 30-70%) caprylic acid, about 50% (e.g., 30-70%) lauric acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. Variations of the third illustrative example can melt by about 15° C. In some variations, C8:0 fatty acid can be replaced or substituted (in part or in whole) with C9:0 (e.g., the about 50% could be 25% C8:0 and 25% C9:0 or 50% C9:0 fatty acid) and C12:0 fatty acid can be replaced or substituted (in part or in whole) with C13:0 fatty acid.

In a fourth illustrative example of a room-temperature semi-solid (e.g., gel) formulation (as shown for instance in Gel 4 of FIG. 5B), a lipid composition of a fat formulation can include about 7.5% (e.g., 5-10%) caproic acid, about 7.5% (e.g., 5-10%) enanthic acid, about 12.5% (e.g., 10-15%) caprylic acid, about 12.5% (e.g., 10-15%) pelargonic acid, about 25% (e.g., 20-30%) lauric acid, about 25% (e.g., 20-30%) tridecylic acid, about 5% (e.g., 2.5-7.5%) myristic acid, and about 5% (e.g., 2.5-7.5%) pentadecylic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. Variations of the fourth illustrative example can melt by about 25° C. In some variations, C6:0 fatty acid can be replaced or substituted (in part or in whole) with C7:0 (e.g., the about 7.5% could be 3.75% C6:0 and 3.75% C7:0 or 7.5% C7:0 fatty acid), C8:0 fatty acid can be replaced or substituted (in part or in whole) with C9:0 fatty acid, C12:0 fatty acid can be replaced or substituted (in part or in whole) with C13:0 fatty acid, and C14:0 fatty acid can be replaced or substituted (in part or in whole) with C15:0 fatty acid.

In a fifth illustrative example of a room-temperature semi-solid (e.g., gel) formulation (as shown for instance in Gel 5 of FIG. 5B), a lipid composition of a fat formulation can include about 50% (e.g., 30-70%) capric acid, about 40% (e.g., 25-55%) lauric acid, and about 10% (e.g., 5-15%) stearic acid, where percentages can refer to mass percentages, approximate mass percentages (e.g., mass percentages neglecting an impact to mass percentage variation resulting from dehydration or formation of esters such as glycerides), volume percentages, stoichiometric percentage, and/or to any suitable percentage. The fatty acids are preferably artificially manufactured, but can be naturally derived (e.g., recovered or sourced from plants, animals, fungi, microbial fermentation, etc.) and/or can otherwise be produced. Variations of the fifth illustrative example can melt by about 20° C. In some variations, C10:0 fatty acid can be replaced or substituted (in part or in whole) with C11:0 (e.g., the about 50% could be 25% C10:0 and 25% C11:0 or 50% C11:0 fatty acid), C12:0 fatty acid can be replaced or substituted (in part or in whole) with C13:0 fatty acid, and C18:0 fatty acid can be replaced or substituted (in part or in whole) with C19:0 fatty acid.

In variations of the preceding specific examples of liquid and/or semi-solid formulations, any or all of the composition for specific even and odd chain fatty acid pairs (e.g., an even chain fatty acid and the odd chain fatty acid with one additional carbon atom in the chain, an odd chain fatty acid and the even chain fatty acid with one fewer carbon atoms in the chain, even and odd fatty acids with melting points that differ by less than 5° C., etc.) can be distributed in any manner. As an illustrative example, when a formulation is listed as including 10% caprylic acid (e.g., C8:0), variations of the formulation can exist with anywhere between 0% caprylic acid and 10% enanthic acid (e.g., C9:0) to 10% caprylic acid and 0% enanthic acid (and any or all values in between such that the total percentage is about 10% distributed between the caprylic acid and enanthic acid). The same can be true for any suitable even and odd chain fatty acid pairs.

In a first specific example, a fat formulation comprising triglycerides comprising glycerol esterified with: odd carbon chain length, linear saturated fatty acids; even carbon chain length, linear saturated fatty acids; and unsaturated fatty acids. In different variations, the triglycerides can be a substantially stochastic distribution of triglycerides formed from the esterification or a non-stochastic distribution (e.g., modified distribution such as removing heavy triglycerides, favoring a location on the glycerol for particular fatty acids such as long chain fatty acids in a 1 position or a 2 position preferentially, etc.).

In a second specific example, the fat formulation of the first specific example, wherein the unsaturated fatty acids comprise linear unsaturated fatty acids.

In a third specific example, the fat formulation of the first or second specific example, the unsaturated fatty acids comprises at most about 30% of a total mass of fatty acids in the triglycerides.

In a fourth specific example, the fat formulation of the first, second, or third specific example a mass distribution of the odd carbon chain length, linear saturated fatty acids and the even carbon chain length, linear saturated fatty acids is nonmonotonically decreasing from a shortest chain length fatty acid to a longest chain length fatty acid.

In a fifth specific example, the fat formulation of the fourth specific example wherein the mass distribution comprises a gap of at least four carbon chain lengths between two successive fatty acids included in the mass distribution.

In a sixth specific example, a fat formulation comprising triglycerides consisting essentially of saturated fatty acids with carbon chain lengths between 4 and 24 carbon atoms long, wherein the fat formulation is a liquid or semi-solid at a temperature between 18-25° C. In different variations, the triglycerides can be a substantially stochastic distribution of triglycerides formed from the esterification or a non-stochastic distribution (e.g., modified distribution such as removing heavy triglycerides, favoring a location on the glycerol for particular fatty acids such as long chain fatty acids in a 1 position or a 2 position preferentially, etc.).

In a seventh specific example, the fat formulation of sixth specific example, wherein a solid fat content of the fat formulation at the temperature between 18-25° C. is at most 10%.

In an eighth specific example, the fat formulation of the sixth or seventh specific example, wherein the triglycerides comprise glycerol esterified with: 0-60% by mass of at least one of C10:0 fatty acid or C11:0 fatty acid; 30-50% by mass of at least one of C12:0 fatty acid or C13:0 fatty acid; and 5-20% by mass of at least one of C18:0 fatty acid or C19:0 fatty acid; wherein the total mass percentage adds up to 100%.

In a ninth specific example, the fat formulation of the sixth or seventh specific example, wherein the triglycerides comprise glycerol esterified with: 40-60% by mass of at least one of C8:0 fatty acid or C9:0 fatty acid; and 40-60% by mass of at least one of C10:0 fatty acid or C11:0 fatty acid; wherein the total mass percentage adds up to 100%.

In a tenth specific example, the fat formulation of the sixth or seventh specific example, wherein the triglycerides comprise glycerol esterified with: 30-50% by mass of at least one of C6:0 fatty acid or C7:0 fatty acid; 40-60% by mass of at least one of C10:0 fatty acid or C11:0 fatty acid; and 5-20% by mass of at least one of C12:0 fatty acid or C13:0 fatty acid; wherein the total mass percentage adds up to 100%.

In an eleventh specific example, the fat formulation of the sixth or seventh specific example, wherein the triglycerides comprise glycerol esterified with: 10-20% by mass of at least one of C6:0 fatty acid or C7:0 fatty acid; 20-30% by mass of at least one of C8:0 fatty acid or C9:0 fatty acid; and 50-70% by mass of at least one of C12:0 fatty acid or C13:0 fatty acid; wherein the total mass percentage adds up to 100%.

In a twelfth specific example, the fat formulation of the sixth or seventh specific example, wherein the triglycerides comprise glycerol esterified with: 30-50% by mass of at least one of C6:0 fatty acid or C7:0 fatty acid; and 50-70% by mass of at least one of C12:0 fatty acid or C13:0 fatty acid; wherein the total mass percentage adds up to 100%.

In a thirteenth specific example, the fat formulation of the sixth or seventh specific example, wherein the triglycerides comprise glycerol esterified with: 10-20% by mass of at least one of C6:0 fatty acid or C7:0 fatty acid; 20-30% by mass of at least one of C8:0 fatty acid or C9:0 fatty acid; 40-60% by mass of at least one of C12:0 fatty acid or C13:0 fatty acid; and 5-20% by mass of at least one of C14:0 fatty acid or C15:0 fatty acid; wherein the total mass percentage adds up to 100%.

In a fourteenth specific example, a method comprising receiving an unsaturated fatty acid; oxidizing hydrocarbons or oxygenates to form saturated fatty acids; selecting a distribution of saturated fatty acids from the formed saturated fatty acids; and esterifying glycerol with the unsaturated fatty acid and the distribution of saturated fatty acids to form a fat composition.

In a fifteenth specific example, the fat formulation of the fourteenth specific example, wherein the formed saturated fatty acids comprise odd chain length fatty acids and even chain length fatty acids.

In a sixteenth specific example, the fat formulation of the fourteenth or fifteenth specific example, wherein the saturated fatty acids comprise linear saturated fatty acids.

In a seventeenth specific example, the fat formulation of the fourteenth, fifteenth, or sixteenth specific example, wherein the distribution of saturated fatty acids is a nonmonotonically decreasing mass distribution of saturated fatty acids from a shortest included chain length fatty acid to a longest included chain length fatty acid.

In an eighteenth specific example, the fat formulation of the seventeenth specific example, wherein the mass distribution comprises a gap of at least four carbon chain lengths that are excluded from the distribution and lie between fatty acids included in the distribution.

In a nineteenth specific example, the fat formulation of the fourteenth, fifteenth, sixteenth, seventeenth, or eighteenth specific example, further comprising combining the fat formulation with a second fat formulation to form a coformulation, wherein the fat formulation and the second fat formulation are combined to achieve a target solid fat content at a target temperature.

In a twentieth specific example, the fat formulation of the nineteenth specific example, wherein the second fat formulation comprises triglycerides consisting essentially of straight chain saturated fatty acids.

In a twenty-first specific example, the fat formulation of the fourteenth, fifteenth, sixteenth, seventeenth, eighteenth, nineteenth, or twentieth specific example, further comprising removing (e.g., via distillation, deodorizing, crystallization, decanting, evaporation, etc.) a portion of heavy triglycerides formed from esterifying glycerol with the distribution of saturated fatty acids.

In a twenty-second specific example, a fat formulation or coformulation formed according to any of the methods of the fourteenth through twenty-first specific examples.

In a twenty-third specific example, a method for manufacturing the fat formulation of any of the first through thirteenth specific examples.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

1. A fat formulation comprising triglycerides comprising glycerol esterified with:
odd carbon chain length, linear saturated fatty acids;
even carbon chain length, linear saturated fatty acids; and
unsaturated fatty acids.

2. The fat formulation of claim 1, wherein the unsaturated fatty acids comprise linear unsaturated fatty acids.

3. The fat formulation of claim 1, the unsaturated fatty acids comprises at most about 30% of a total mass of fatty acids in the triglycerides.

4. The fat formulation of claim 1, wherein a mass distribution of the odd carbon chain length, linear saturated fatty acids and the even carbon chain length, linear saturated fatty acids is nonmonotonically decreasing from a shortest chain length fatty acid to a longest chain length fatty acid.

5. The fat formulation of claim 4, wherein the mass distribution comprises a gap of at least four carbon chain lengths between two successive fatty acids included in the mass distribution.

6. A fat formulation comprising triglycerides consisting essentially of saturated fatty acids with carbon chain lengths between 4 and 24 carbon atoms long, wherein the fat formulation is a liquid or semi-solid at a temperature between 18-25° C.

7. The fat formulation of claim 6, wherein a solid fat content of the fat formulation at the temperature between 18-25° C. is at most 10%.

8. The fat formulation of claim 6, wherein the triglycerides comprise glycerol esterified with:
40-60% by mass of at least one of C10:0 fatty acid or C11:0 fatty acid;
30-50% by mass of at least one of C12:0 fatty acid or C13:0 fatty acid; and
5-20% by mass of at least one of C18:0 fatty acid or C19:0 fatty acid;
wherein the total mass percentage adds up to 100%.

9. The fat formulation of claim 6, wherein the triglycerides comprise glycerol esterified with:
40-60% by mass of at least one of C8:0 fatty acid or C9:0 fatty acid; and
40-60% by mass of at least one of C10:0 fatty acid or C11:0 fatty acid;
wherein the total mass percentage adds up to 100%.

10. The fat formulation of claim 6, wherein the triglycerides comprise glycerol esterified with:
30-50% by mass of at least one of C6:0 fatty acid or C7:0 fatty acid;
40-60% by mass of at least one of C10:0 fatty acid or C11:0 fatty acid; and
5-20% by mass of at least one of C12:0 fatty acid or C13:0 fatty acid;
wherein the total mass percentage adds up to 100%.

11. The fat formulation of claim 6, wherein the triglycerides comprise glycerol esterified with:
10-20% by mass of at least one of C6:0 fatty acid or C7:0 fatty acid;
20-30% by mass of at least one of C8:0 fatty acid or C9:0 fatty acid; and
50-70% by mass of at least one of C12:0 fatty acid or C13:0 fatty acid;
wherein the total mass percentage adds up to 100%.

12. The fat formulation of claim 6, wherein the triglycerides comprise glycerol esterified with:
30-50% by mass of at least one of C6:0 fatty acid or C7:0 fatty acid; and
50-70% by mass of at least one of C12:0 fatty acid or C13:0 fatty acid;
wherein the total mass percentage adds up to 100%.

13. The fat formulation of claim 6, wherein the triglycerides comprise glycerol esterified with:
10-20% by mass of at least one of C6:0 fatty acid or C7:0 fatty acid;
20-30% by mass of at least one of C8:0 fatty acid or C9:0 fatty acid;
40-60% by mass of at least one of C12:0 fatty acid or C13:0 fatty acid; and
5-20% by mass of at least one of C14:0 fatty acid or C15:0 fatty acid;
wherein the total mass percentage adds up to 100%.

14. A method comprising:
receiving an unsaturated fatty acid;
oxidizing hydrocarbons or oxygenates to form saturated fatty acids;
selecting a distribution of saturated fatty acids from the formed saturated fatty acids; and
esterifying glycerol with the unsaturated fatty acid and the distribution of saturated fatty acids to form a fat composition.

15. The method of claim 14, wherein the formed saturated fatty acids comprise odd chain length fatty acids and even chain length fatty acids.

16. The method of claim 14, wherein the saturated fatty acids comprise linear saturated fatty acids.

17. The method of claim 14, wherein the distribution of saturated fatty acids is a nonmonotonically decreasing mass distribution of saturated fatty acids from a shortest included chain length fatty acid to a longest included chain length fatty acid.

18. The method of claim 17, wherein the mass distribution comprises a gap of at least four carbon chain lengths that are excluded from the distribution and lie between fatty acids included in the distribution.

19. The method of claim 14, further comprising combining the fat formulation with a second fat formulation to form a coformulation, wherein the fat formulation and the second fat formulation are combined to achieve a target solid fat content at a target temperature.

20. The method of claim 19, wherein the second fat formulation comprises triglycerides consisting essentially of straight chain saturated fatty acids.

21. The method of claim 14, further comprising removing a portion of heavy triglycerides formed from esterifying glycerol with the distribution of saturated fatty acids.
